(19) United States
(12) Patent Application Publication
(10) Pub. No.: US 2026/0323333 A1
(43) Pub. Date: Oct. 15, 2026

(54) DEFAULT DATA SUBSCRIPTION SELECTION FOR MULTICAST-BROADCAST SERVICES

(71) Applicant: QUALCOMM Incorporated, San Diego, CA (US)

(72) Inventors: Hargovind Prasad BANSAL, Bharatpur (IN); Alberto RICO ALVARINO, San Diego, CA (US); Akash KUMAR, Hyderabad (IN)

(21) Appl. No.: 19/485,218

(22) PCT Filed: May 28, 2024
(86) PCT No.: PCT/US2024/031266

§ 371 Date: Nov. 17, 2025

(30) Foreign Application Priority Data
Jun. 23, 2023 (IN) 202321042009

(51) Int. Cl. H04W 24/08; H04W 8/20; H04W 72/30

(52) U.S. Cl. CPC H04W 24/08; H04W 8/20; H04W 72/30

(57) ABSTRACT

Various aspects of the present disclosure generally relate to wireless communication. Some aspects more specifically relate to selecting a default data subscription to improve performance for multicast-broadcast services (MBS) for a user equipment (UE) having multiple data subscriptions. For example, the UE may measure a signal-to-noise ratio (SNR) associated with one or more MBS resources associated with an inactive data subscription responsive to an SNR associated with MBS transmissions received via an active SIM failing to satisfy a first condition (for example, failing to equal or exceed a threshold for at least a threshold duration). In such cases, the UE may switch a default data subscription from the current SIM to the inactive SIM responsive to the SNR associated with the MBS resources on the second SIM satisfying a second condition (for example, equaling or exceeding a threshold for at least a threshold duration).

### CROSS-REFERENCE TO RELATED APPLICATION

This Patent Application claims priority to India Provisional Patent Application No 202321042009, filed on Jun. 23, 2023, entitled “DEFAULT DATA SUBSCRIPTION SELECTION FOR MULTICAST-BROADCAST SERVICES,” which is hereby expressly incorporated by reference herein.

### FIELD OF THE DISCLOSURE

Aspects of the present disclosure generally relate to wireless communication and specifically, to techniques and apparatuses associated with default data subscription selection for multicast-broadcast services (MBS).

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, system bandwidth and/or device transmit power). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies, massive multiple-input multiple-output (MIMO), disaggregated network architectures and network topology expansions, multiple-subscriber implementations, and/or high-precision positioning, among other examples. As the demand for mobile broadband access continues to increase, further improvements in NR may be implemented, and other radio access technologies such as 6G may be introduced to further advance mobile broadband evolution.

In some cases, a multicast-broadcast services (MBS) architecture may be deployed in a wireless network to support multicast and/or broadcast services to simultaneously disseminate data, such as emergency alerts or audio or video content, among many other possibilities, to multiple UEs that may be located in the same or different cells. For example, a multicast transmission (sometimes referred to as a “one-to-many” communication) may be a transmission of the same information or content to multiple UEs that join a multicast session. For example, a network node may transmit multicast transmissions to a subset of the UEs within an area referred to as a multicast service area. Alternatively, a broadcast transmission (sometimes referred to as a “one-to-all” communication) may be a communication of the same information or content to all UEs within an area referred to as a broadcast service area. Unlike for multicast transmissions, the UEs within a broadcast service area may not need to join a session prior to receiving the broadcast transmissions. In general, because multicast and/or broadcast (“multicast-broadcast”) operations enable multiple UEs to receive the same data at substantially the same time, multicast-broadcast operations can significantly reduce network overhead relative to unicast operations in which a particular transmission is intended for and received by only one UE.

However, in some cases, supporting MBS in a wireless network may pose various challenges. For example, in an NTN deployment where various UEs in a multicast or broadcast service area are served by a satellite beam that covers a large geographic area, there may be significant signal-to-noise ratio (SNR) fluctuation within the coverage area of the satellite beam (for example, due to variations in a propagation environment, local interference, mobility, and/or hardware capabilities of devices within the coverage area, among other examples). For example, within the coverage area of a single beam, satellite transmissions may be relatively weak in some areas and relatively strong in other areas. Furthermore, similar issues may arise in terrestrial networks and/or other settings where a beam covers a large area or there is otherwise SNR fluctuation throughout a coverage area. However, when MBS reception is weak in a given MBS area, a UE may be unable to report the SNR to the wireless network in real-time, and/or the wireless network may be unable to implement timely corrective actions to improve MBS coverage within the MBS area. For example, in some cases, MBS communication may be configured in a receive-only mode, in which case the UE may be unable to transmit messages to the wireless network to indicate the current SNR. Furthermore, in cases where MBS communication is not configured in a receive-only mode, the uplink delay (for example, in an NTN) may interfere with the ability of the wireless network to implement timely corrections, which can result in severely degraded MBS performance.

### SUMMARY

Some aspects described herein relate to a user equipment (UE) for wireless communication. The UE may include one or more memories storing processor-executable code and one or more processors coupled with the one or more memories. The one or more processors may be individually or collectively configured to, when executing the processor-executable code, cause the UE to measure a first signal-to-noise ratio (SNR) associated with one or more multicast-broadcast services (MBS) transmissions received via a first subscriber identity module (SIM) associated with a first data subscription. The one or more processors may be individually or collectively configured to, when executing the processor-executable code, cause the UE to measure, responsive to the first SNR failing to satisfy a first condition, a second SNR associated with one or more MBS resources on a second SIM associated with a second data subscription. The one or more processors may be individually or collectively configured to, when executing the processor-executable code, cause the UE to switch a default data subscription from the first data subscription to the second data subscription responsive to the second SNR satisfying a second condition.

Some aspects described herein relate to a method for wireless communication by a UE. The method may include measuring a first SNR associated with one or more MBS transmissions received via a first SIM associated with a first data subscription. The method may include measuring, responsive to the first SNR failing to satisfy a first condition, a second SNR associated with one or more MBS resources on a second SIM associated with a second data subscription. The method may include switching a default data subscription from the first data subscription to the second data subscription responsive to the second SNR satisfying a second condition.

Some aspects described herein relate to a non-transitory computer-readable medium that stores a set of instructions for wireless communication by a UE. The set of instructions, when executed by one or more processors of the UE, may cause the UE to measure a first SNR associated with one or more MBS transmissions received via a first SIM associated with a first data subscription. The set of instructions, when executed by one or more processors of the UE, may cause the UE to measure, responsive to the first SNR failing to satisfy a first condition, a second SNR associated with one or more MBS resources on a second SIM associated with a second data subscription. The set of instructions, when executed by one or more processors of the UE, may cause the UE to switch a default data subscription from the first data subscription to the second data subscription responsive to the second SNR satisfying a second condition.

Some aspects described herein relate to an apparatus for wireless communication. The apparatus may include means for measuring a first SNR associated with one or more MBS transmissions received via a first SIM associated with a first data subscription. The apparatus may include means for measuring, responsive to the first SNR failing to satisfy a first condition, a second SNR associated with one or more MBS resources on a second SIM associated with a second data subscription. The apparatus may include means for switching a default data subscription from the first data subscription to the second data subscription responsive to the second SNR satisfying a second condition.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The appended drawings illustrate some aspects of the present disclosure, but are not limiting of the scope of the present disclosure because the description may enable other aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating examples of satellite deployments in a non-terrestrial network (NTN) in accordance with the present disclosure.

FIG. 4 is a diagram illustrating an example of a multicast-broadcast service (MBS) architecture in accordance with the present disclosure.

FIG. 5 is a diagram illustrating an example of a channel mapping for multicast broadcast services (MBS) communications in accordance with the present disclosure.

FIG. 6 is a diagram illustrating an example associated with default data subscription selection for MBS in accordance with the present disclosure.

FIG. 7 is a flowchart illustrating an example process performed, for example, by a UE in accordance with the present disclosure.

FIG. 8 is a diagram of an example apparatus for wireless communication in accordance with the present disclosure.

### DETAILED DESCRIPTION

Various aspects of the disclosure are described hereinafter with reference to the accompanying drawings. However, this disclosure may be embodied in many different forms and is not to be construed as limited to any specific aspect presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using any quantity of the aspects set forth herein. In addition, the scope of the disclosure is intended to cover an apparatus or method that is practiced using another structure, functionality, or structure and functionality in addition to or other than the various aspects of the disclosure set forth herein.

Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to techniques that a user equipment (UE) may implement to enable fast corrective action to improve performance for multicast-broadcast services (MBS) when one or more conditions are satisfied, without having to wait for or rely upon a wireless network to correct issues that may be degrading MBS performance. Some aspects more specifically relate to switching or selecting a default data subscription to improve MBS performance for a UE that has multiple data subscriptions (for example, for different mobile network operators (MNOs) or account tiers). For example, in some aspects, a UE equipped with multiple subscriber identity modules (SIMs) may have a first data subscription associated with a first SIM and a second data subscription associated with a second SIM. In such cases, when the UE is receiving MBS transmissions via the first SIM, the UE may generally measure and monitor a signal-to-noise ratio (SNR) associated with the MBS transmissions received via the first SIM and check whether a second data subscription associated with a second SIM offers better performance when MBS reception is underperforming on the first SIM. For example, in some aspects, the UE may measure an SNR associated with one or more MBS resources associated with the second data subscription responsive to the SNR associated with the MBS transmissions received via the first SIM failing to satisfy a first condition (for example, failing to equal or exceed a threshold value for at least a threshold duration). In some aspects, the UE may then switch a default data subscription from the first SIM to the second SIM (for example, making the second data subscription the default data subscription) responsive to the SNR associated with the MBS resources on the second SIM satisfying a second condition (for example, equaling or exceeding a threshold value for at least a threshold duration).

Particular aspects of the subject matter described in this disclosure can be implemented to realize one or more of the following potential advantages. In some examples, the described techniques can be used to improve MBS performance by switching a default (or current) data subscription from an active SIM to an inactive SIM when MBS is underperforming on the active SIM and better MBS performance is available on the inactive SIM. Furthermore, in some examples, the described techniques can be used to improve MBS performance by implementing corrective actions at the UE receiving MBS transmissions, without having to report an SNR or other MBS metrics to a wireless network or otherwise rely upon corrective measures being implemented by the wireless network. Furthermore, in some examples, the described techniques can be used to improve MBS performance in cases where MBS is configured in a receive-only mode or there are any other factors that impede the ability of a UE to report an SNR or other MBS metrics to a wireless network and/or the ability of a wireless network to implement timely corrective measures to improve degraded MBS performance.

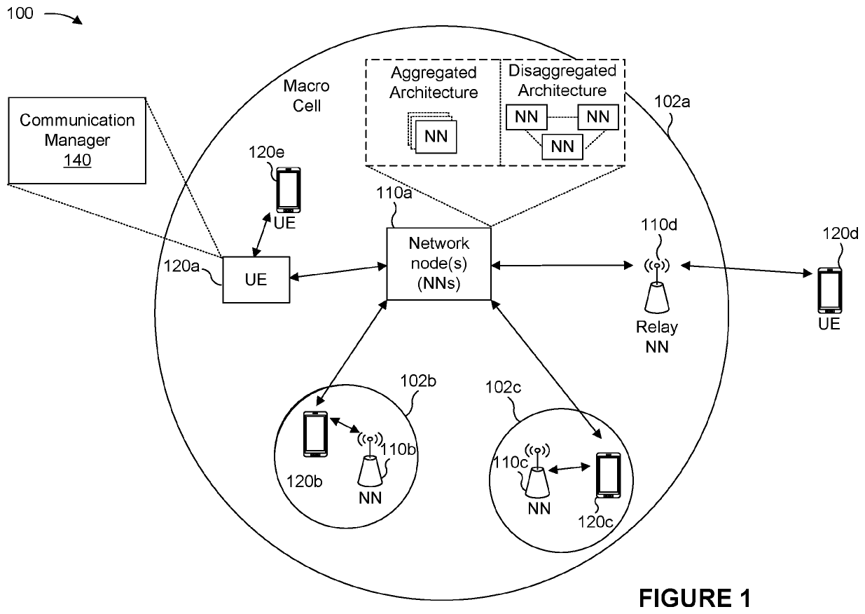

FIG. 1 is a diagram illustrating an example of a wireless network 100 in accordance with the present disclosure. The wireless network 100 may be or may include elements of a 5G (or New Radio (NR)) network or a 6G network, among other examples. The wireless network 100 may include multiple network nodes 110 (also referred to as network entities), shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

A network node 110 may include one or more devices that enable communication between a UE 120 and one or more components of the wireless network 100. A network node 110 may be, may include, or may be referred to as an NR network node, a 6G network node, a Node B, an eNB (for example, in 4G), a gNB (for example, in 5G), an access point (AP), a transmission reception point (TRP), a mobility element of a network, a core network node, a network element, a network equipment, and/or another type of device or devices included in a radio access network (RAN).

A network node 110 may be a single physical node or may be two or more physical nodes. For example, a network node 110 may be a device or system that implements part of a radio protocol stack, a device or system that implements a full protocol stack (such as a full gNB protocol stack), or a collection of devices or systems that collectively implement the full protocol stack. For example, and as shown, a network node 110 may be an aggregated network node, meaning that the network node 110 may use a radio protocol stack that is physically and logically integrated within a single node in the wireless network 100. For example, an aggregated network node 110 may consist of a single standalone base station or a single TRP that uses a full radio protocol stack to enable or facilitate communication between a UE 120 and a core network of the wireless network 100.

Alternatively, and as also shown, a network node 110 may be a disaggregated network node (sometimes referred to as a disaggregated base station), meaning that the network node 110 may use a protocol stack that is physically distributed and/or logically distributed among two or more nodes in the same geographic location or in different geographic locations. In some deployments, disaggregated network nodes 110 may be used in an integrated access and backhaul (IAB) network, in an open radio access network (O-RAN), such as the network configuration sponsored by the O-RAN Alliance, or in a virtualized radio access network (vRAN), also known as a cloud radio access network (C-RAN), to facilitate scaling of communication systems by separating base station functionality into multiple units that can be individually deployed.

The network nodes 110 of the wireless network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A CU may handle user plane functionality (for example, Central Unit-User Plane (CU-UP) functionality), and/or control plane functionality (for example, Central Unit-Control Plane (CU-CP) functionality). A DU may host one or more of a radio link control (RLC) layer, a medium access control (MAC) layer, and/or one or more high physical (PHY) layers depending, at least in part, on a functional split, such as a functional split defined by the Third Generation Partnership Project (3GPP). In some examples, a DU may host one or more low PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or low PHY layer functions, such as an FFT, an iFFT, beamforming, or PRACH extraction and filtering, among other examples, based on a functional split, such as a lower layer functional split. In such an architecture, each RU can be operated to handle over the air (OTA) communication with one or more UEs 120.

In some aspects, a network node 110 may include a combination of one or more CUs, one or more DUs, one or more RUs, one or more IAB nodes, one or more Near-Real Time (Near-RT) RAN Intelligent Controllers (RICs), and/or one or more Non-Real Time (Non-RT) RICs in the wireless network 100. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as within a cloud deployment.

In some examples, a network node 110 may be, may include, or may operate as an RU, a TRP, or a base station that communicates with one or more UEs 120 via a radio access link (which may be referred to as a “Uu” link or an access link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may include one or more control channels and one or more data channels. An uplink control channel may be used to transmit uplink control information (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

In some examples, the wireless network 100 may be configured for half-duplex communications and/or full-duplex communications. In half-duplex operation, a network node 110 and/or a UE 120 may only transmit or receive communications during particular time periods, such as during particular slots, symbols, or other transmission time intervals (TTIs). For example, in half-duplex operation, a wireless communication device may perform only one of transmission or reception in a particular time instance. In full-duplex operation, a wireless communication device (such as the network node 110 and/or the UE 120) may transmit and receive communications simultaneously (for example, in the same time instance). For example, a UE 120 may communicate with two network nodes 110 in a configuration that may be referred to as a multi-TRP (mTRP) configuration. In some examples, full-duplex operation may be enabled for a UE 120 but not for a network node 110. For example, a UE 120 may simultaneously transmit an UL transmission to a first network node 110 and receive a DL transmission from a second network node 110 in the same time instance. In some other examples, full-duplex operation may be enabled for a network node 110 but not for a UE 120. For example, a network node 110 may simultaneously transmit a DL transmission to a first UE 120 and receive an UL transmission from a second UE 120 in the same time instance. In some examples, full-duplex operation may be enabled for both a network node 110 and a UE 120. Full-duplex communication increases the capacity of the network and the radio access link.

The UEs 120 may be physically dispersed throughout the wireless network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 may include or may be included in a housing that houses components associated with the UE 120, such as one or more processor components and/or one or more memory components. One or more of the processor components may be coupled with one or more of the memory components and/or other components. For example, the processor components (for example, one or more processors) and the memory components (for example, a memory) may be operatively coupled, communicatively coupled, electronically coupled, or electrically coupled with one another.

Some UEs 120 may be considered machine-type communication (MTC) or evolved or enhanced machine-type communication (eMTC) UEs (or further enhanced eMTC (feMTC), or enhanced feMTC (efeMTC), or further evolutions thereof, all of which may be simply referred to as “MTC”). An MTC UE may be, may include, or may be included in or coupled with a robot, a drone, a remote device, a sensor, a meter, a monitor, and/or a location tag. Some UEs 120 may be considered IoT devices and/or may be implemented as NB-IOT (narrowband IoT) devices. An IoT UE or NB-IOT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless network 100).

Some UEs 120 may be classified according to different categories in association with different complexities and/or different capabilities. UEs 120 in a first category may facilitate massive IoT in the wireless network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between capability and complexity of NB-IOT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart cities deployment, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may communicate using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless network 100. In some other deployments and configurations, a UE 120 (instead of a network node 110) may perform, or collaborate or negotiate with one or more other UEs to perform, scheduling operations, resource selection operations, and/or other operations described elsewhere herein for sidelink communications.

Downlink and uplink resources may include time domain resources (frames, subframes, slots, symbols), frequency domain resources (frequency bands, frequency carriers, subcarriers, resource blocks, resource elements), spatial domain resources (particular transmit directions or beam parameters), or a combination thereof. Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP. A BWP may be dynamically configured (for example, by a network node 110 transmitting a downlink control information (DCI) configuration to the one or more UEs 120) and/or reconfigured, which means that a BWP can be adjusted in real-time (or near-real-time) based on changing network conditions in the wireless network 100 and/or based on the specific requirements of the one or more UEs 120. This enables more efficient use of the available frequency domain resources in the wireless network 100 in that smaller amounts of frequencies may be allocated to a BWP for a UE 120 (which may reduce the amount of frequencies that a UE 120 is required to monitor), leaving a greater amount of frequencies to be spread across multiple UEs 120. Thus, BWPs may also assist in the implementation of lower-capability UEs 120 by facilitating the configuration of smaller bandwidths for communication by such UEs 120.

As indicated above, a BWP may be configured as a subset or a part of a total or full component carrier bandwidth and generally forms or encompasses a set of contiguous common resource blocks (CRBs) within the full component carrier bandwidth. In other words, within the carrier bandwidth, a BWP starts at a CRB and may span over a set of consecutive CRBs. Each BWP may be associated with its own numerology (indicating a sub-carrier spacing (SCS) and cycling prefix (CP)). A UE 120 may be configured with up to four downlink BWPs and up to four uplink BWPs for each serving cell. To enable reasonable UE battery consumption, only one BWP in the downlink and one BWP in the uplink are generally active at a given time on an active serving cell under typical operation. The active BWP defines the UE 120's operating bandwidth within the cell's operating bandwidth while all other BWPs that the UE 120 is configured with are deactivated. On deactivated BWPs, the UE 120 does not transmit or receive any data.

Some network nodes 110 (for example, a base station, an RU, or a TRP) may provide communication coverage for a particular geographic area. In the 3GPP, the term “cell” can refer to a coverage area of a network node 110 or a network node subsystem serving such a coverage area, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

As is evident, the wireless network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 102a, the network node 110b may be a pico network node for a pico cell 102b, and the network node 110c may be a femto network node for a femto cell 102c. Various different types of network nodes 110 may generally transmit at different power levels, serve different coverage areas, and/or have different impacts on interference in the wireless network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

As indicated above, a network node 110 may be a terrestrial network node 110 (for example, a terrestrial base station or entity of a disaggregated base station) or an NTN node 110. For example, the wireless network 100 may include one or more NTN deployments that may include an NTN node 110 and/or a relay station (referred to herein, interchangeably, as a “non-terrestrial relay station”). An NTN may facilitate access to the wireless network 100 for remote areas that may not otherwise be within a coverage area of a terrestrial network node 110, such as over seas, over oceans, or in remote areas in which a terrestrial network is not deployed. An NTN may provide connectivity for various applications, including satellite communications, IoT, MTC, and/or other applications associated with high speed, low latency, and/or high reliability. In some aspects, an NTN node 110 may include a satellite, a manned aircraft system, and/or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, helicopter, and/or a dirigible, among other examples. A UAS platform may include a high-altitude platform station (HAPS), and may include a balloon, a dirigible, and/or an airplane, among other examples.

An NTN node 110 may communicate directly and/or indirectly with other entities in the wireless network 100 using NTN communication. The other entities may include UEs 120, other NTN nodes 110 in the one or more NTN deployments, other types of network nodes 110 (for example, stationary, terrestrial, or ground-based network nodes), relay stations, and/or one or more components and/or devices included in or coupled with a core network of wireless network 100. For example, an NTN node 110 may communicate with a UE 120 via a service link (for example, where the service link includes an access link). Additionally or alternatively, an NTN node 110 may communicate with a gateway (for example, a terrestrial node providing connectivity for the NTN node 110 to a data network or a core network) via a feeder link (for example, where the feeder link is associated with an N2 or an N3 interface). NTN nodes 110 may communicate directly with one another via an inter-satellite link (ISL). An NTN deployment may be transparent (for example, where the NTN node 110 operates in a similar manner as a repeater or relay and/or where an access link does not terminate at the NTN node 110) or regenerative (for example, where the NTN node 110 regenerates a signal and/or where an access link terminates at the NTN node 110).

The network nodes 110 and UEs 120 of the wireless network 100 may communicate using the electromagnetic spectrum, which may be subdivided by frequency or wavelength into various classes, bands, carriers, and/or channels. For example, devices of the wireless network 100 may communicate using one or more operating bands. In some aspects, multiple wireless networks 100 may be deployed in a given geographic area. Each wireless network 100 may support a particular radio access technology (RAT) (which may also be referred to as an air interface) and may operate on one or multiple carrier frequencies in one or multiple frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies in order to avoid interference with one another.

Various operating bands have been defined as frequency range designations FR1 (410 MHz-7.125 GHZ), FR2 (24.25 GHz-52.6 GHZ), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Although a portion of FRI is greater than 6 GHZ, FRI is often referred to (interchangeably) as a “sub-6 GHz” band in various documents and articles. Accordingly, the term “sub-6 GHZ,” if used herein, may broadly refer to frequencies that may be less than 6 GHz, may be within FR 1, or may include mid-band frequencies. A similar nomenclature issue sometimes occurs in connection with FR2, which is often referred to (interchangeably) as a “millimeter wave” band in documents and articles, despite being different from the extremely high frequency (EHF) band (30 GHz 300 GHz), which is identified by the International Telecommunications Union (ITU) as a “millimeter wave” band. The frequencies between FR1 and FR2 are often referred to as mid-band frequencies, which include FR3. Accordingly, unless specifically stated otherwise, the term “millimeter wave,” if used herein, may broadly refer to frequencies that may include mid-band frequencies, may be within FR2, FR4, FR4-a or FR4-1, or FR5, or may be within the EHF band. Frequency bands falling within FR3 may inherit FR1 characteristics or FR2 characteristics, and thus may effectively extend features of FR1 or FR2 into mid-band frequencies. Higher frequency bands may extend 5G NR operation, 6G operation, and/or other RATs beyond 52.6 GHz. For example, each of FR4a, FR4-1, FR4 and FR5 falls within the EHF band. In some examples, wireless network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. Further, it is contemplated that the frequencies included in these operating bands (for example, FR1, FR2, FR3, FR4, FR4-a, FR4-1, or FR5) may be modified, and techniques described herein may be applicable to those modified frequency ranges.

In some aspects, the UE 120 may include a communication manager 140. As described in more detail elsewhere herein, the communication manager 140 may measure a first SNR associated with one or more MBS transmissions received via a first SIM associated with a first data subscription; measure, responsive to the first SNR failing to satisfy a first condition, a second SNR associated with one or more MBS resources on a second SIM associated with a second data subscription; and switch a default data subscription from the first data subscription to the second data subscription responsive to the second SNR satisfying a second condition. Additionally or alternatively, the communication manager 140 may perform one or more other operations described herein.

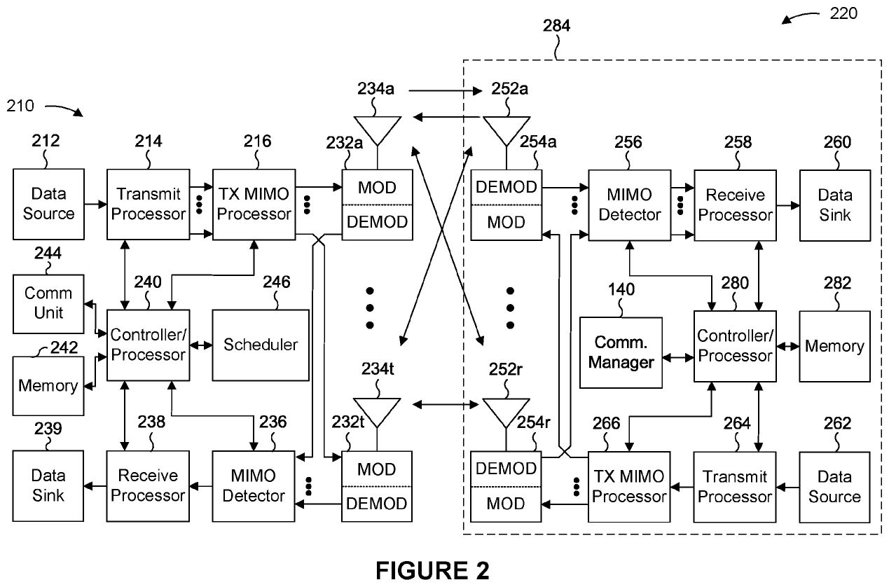

FIG. 2 is a diagram illustrating an example network node 210 in communication with an example UE 220 in a wireless network in accordance with the present disclosure. The network node 210 of FIG. 2 may be an example of the network node 110 described with reference to FIG. 1. Similarly, the UE 220 may be an example of the UE 120 described with reference to FIG. 1.

As shown in FIG. 2, the network node 210 may include a data source 212, a transmit processor 214, a transmit (TX) multiple-input multiple-output (MIMO) processor 216, a set of modems 232 (such as 232a through 232t, where t≥1), a set of antennas 234 (such as 234a through 234t, where t≥1), a MIMO detector 236, a receive processor 238, a data sink 239, a controller/processor 240, a memory 242, a communication unit 244, and/or a scheduler 246, among other examples. In some aspects, one or a combination of the antenna(s) 234, the modem(s) 232, the MIMO detector 236, the receive processor 238, the transmit processor 214, or the TX MIMO processor 216 may be included in a transceiver of the network node 210. The transceiver may be under control of and used by a processor, such as the controller/processor 240, and in some aspects in conjunction with processor-readable code stored in the memory 242, to perform aspects of the methods, processes or operations described herein. The terms “processor,” “controller” or “controller/processor” may refer to one or more controllers and/or one or more processors. For example, reference to “a/the processor” or “a/the controller/processor” (in the singular) should be understood to refer to any one or more of the processors described in connection with FIG. 2 (for example, a single processor or a combination of multiple different processors). Similarly, reference to “a/the memory” should be understood to refer to any one or more memories of the corresponding device or node (for example, a single memory or a combination of multiple different memories). In some aspects, the network node 210 may include one or more interfaces, communication components, or other components that facilitate communication with the UE 220 or another network node.

For downlink communication from the network node 210 to the UE 220, the transmit processor 214 may receive data (“downlink data”) intended for the UE 220 (or a set of UEs that includes the UE 220) from the data source 212 (such as a data pipeline or a data queue). In some examples, the transmit processor 214 may select one or more MCSs for the UE 220 in accordance with one or more channel quality indicators (CQIs) received from the UE 220. The network node 210 may process the data (for example, including encoding the data) for transmission to the UE 220 on a downlink in accordance with the MCS(s) selected for the UE 220 to generate data symbols. The transmit processor 214 may process system information (for example, semi-static resource partitioning information (SRPI)) and control information (for example, CQI requests, grants, or upper layer signaling) and provide overhead symbols and control symbols. The transmit processor 214 may generate reference symbols for reference signals (for example, a cell-specific reference signal (CRS), a demodulation reference signal (DMRS), or a channel state information (CSI) reference signal (CSI-RS)) and synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions on the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 220 to the network node 210, uplink signals from the UE 220 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and control information. The receive processor 238 may provide the decoded data to a data sink 239 (which may be a data pipeline, a data queue, and/or another data sink) and provide the decoded control information to a processor, such as the controller/processor 240.

One or more antennas of the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays.

In some examples, each of the antenna elements of an antenna 234 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, half wavelength, or other fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other so as to generate one or more beams. The term “beam” may, at a basic level, refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, horizontal direction, and/or vertical direction), and/or a set of parameters that indicate one or more aspects of a directional signal, a direction associated with the signal, and/or a set of directional resources associated with the signal. Beamforming includes generation of a beam using multiple signals on different antenna elements, where one or more, or all, of the multiple signals are shifted in phase relative to each other. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the amplitudes and phase shifts or phase offsets of the multiple signals relative to each other.

Different UEs 220 may include different numbers of antenna elements. For example, a UE may include a single antenna element, two antenna elements, four antenna elements, eight antenna elements, or a different number of antenna elements. Generally, a larger number of antenna elements may provide increased control over parameters of beam generation relative to a smaller number of antenna elements, whereas a smaller number of antenna elements may be less complex to implement and may use less power than a larger number of antenna elements.

Multiple antenna elements may support multiple-layer transmission, in which a first layer of a communication (which may include a first data stream) is transmitted using a first set of antenna elements and a second layer of a communication (which may include a second data stream) is transmitted using a second set of antenna elements.

The network node 210 may provide the UE 220 with a configuration of transmission configuration indicator (TCI) states that respectively indicate or correspond to beams that may be used by the UE 220, such as for receiving a PDCCH or a PDSCH. For example, the network node 210 may indicate (for example, using DCI) an activated TCI state to the UE 220, which the UE 220 may use to generate a beam for receiving the PDSCH.

A beam indication (an indication of a beam) may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate particular information associated with a beam. For example, the TCI state information element may indicate a TCI state identification (for example, a tci-StateID), a quasi-co-location (QCL) type (for example, a qcl-Type 1, qcl-Type2, qcl-TypeA, qcl-TypeB, qcl-TypeC, and/or qcl-TypeD), a cell identification (for example, a ServCellIndex), a bandwidth part identification (bwp-Id), a reference signal identification such as a CSI-RS identification (for example, an NZP-CSI-RS-ResourceId, and/or an SSB-Index), among other examples. Spatial relation information may similarly indicate information associated with an uplink beam. The beam indication may be a joint or separate downlink/uplink beam indication in a unified TCI framework. In some cases, the network may support a layer 1 (L1)-based beam indication using at least UE-specific (unicast) DCI to indicate joint or separate DL/UL beam indications. In some cases, existing DCI formats 1_1 and/or 1_2 may be reused for beam indication. The network node 210 may include a support mechanism for the UE 220 to acknowledge successful decoding of a beam indication. For example, the acknowledgment/negative acknowledgment of the PDSCH scheduled by the DCI carrying the beam indication may be also used as an ACK for the DCI.

Further efficiencies in throughput, signal strength, and/or other signal properties may be achieved through beam refinement. For example, the network node 210 may be capable of communicating with the UE 220 using beams of various beam widths. For example, the network node 210 may be configured to utilize a wider beam when communicating with the UE 220 when the UE 220 is in motion because of the wider coverage needed to ensure that the UE 220 remains in coverage of the network node 210 when moving. Conversely, the UE 220 may use a narrower beam when communicating with the UE 220 when the UE 220 is stationary because the network node 210 can reliably focus coverage on the UE 220 with low or minimal likelihood of the UE 220 moving out of the coverage area of the network node 210. In some examples, to select a particular beam for communication with a UE 220, the base station may transmit a reference signal, such as a synchronization signal block (SSB) or CSI-RS, on each of a plurality of beams in a beam-sweeping manner. In some examples, SSBs may be transmitted on wider beams, whereas CSI-RSs may be transmitted on narrower beams. The UE 220 may measure a reference signal received power (RSRP) or a signal-to-interference-plus-noise ratio (SINR) on each of the beams and transmit a beam measurement report (for example, a Layer 1 (L1) measurement report) to the network node 210 indicating the RSRP or SINR associated with each of one or more of the measured beams. The network node 210 may then select the particular beam for communication with the UE 220 based on the LI measurement report. In some other examples, when there is uplink and downlink channel reciprocity, the network node 210 may derive the particular beam to communicate with the UE 220 based on uplink measurements of one or more uplink reference signals, such as an SRS, transmitted by the UE 220.

One enhancement for multi-beam operation at higher carrier frequencies is facilitation of efficient (for example, low latency and low overhead) downlink and/or uplink beam management operations to support higher Layer 1 and/or Layer 2 (L1/L2)-centric inter-cell mobility. L1 and/or L2 signaling may be referred to as “lower layer” signaling and may be used to activate and/or deactivate candidate cells in a set of cells configured for L1/L2 mobility and/or to provide reference signals for measurement by the UE 220, by which the UE 220 may select a candidate beam as a target beam for a lower layer handover operation. Accordingly, one goal for L1/L2-centric inter-cell mobility is to enable a UE to perform a cell switch via dynamic control signaling at lower layers (for example, DCI for L1 signaling or a MAC CE for L2 signaling), rather than semi-static Layer 3 (L3) RRC signaling, in order to reduce latency, reduce overhead, and/or otherwise increase efficiency of the cell switch.

In some examples, for a UE 220, UL transmission may be performed using one antenna panel, and DL reception may be performed using another antenna panel (for example, to minimize self-interference). In some examples, full-duplex communication may be conditional on a beam separation of the UL beam and DL beam at the respective antenna panels. Utilizing full-duplex communication may provide a reduction in latency, such that it may be possible to receive a DL signal in UL-only slots, which may enable latency savings. In addition, full-duplex communication may enhance spectrum efficiency per cell or per UE 220, and may enable a more efficient utilization of resources. Beam separation of the UL and DL beams assists in limiting or reducing self-interference that may occur during full duplex communication. Determining the UL and DL beams that are separated on their respective antenna panels may provide a reliable full duplex communication by using beam pairs that minimize or reduce self-interference.

A full-duplex UE 220 may perform a self-interference measurement procedure in order to identify self-interference from transmissions of the full-duplex UE 220. A full-duplex network node 210 also may perform a self-interference measurement procedure in order to identify self-interference from transmissions of the full-duplex network node 210. The UE 220 may provide a measurement report to the network node 210 to indicate results of the UE self-interference measurement. The network node 210 may select pairs of beams (referred to herein as “beam pairs”) for the UE (“UE beam pairs”) 220 and the network node (“network node beam pairs”) 210 to use during full-duplex communications. A beam pair generally includes a receive (Rx) beam and a transmit (Tx) beam, such as a DL beam and an UL beam, respectively, for the UE 220, and similarly, an UL beam and a DL beam, respectively, for the network node 210.

The network node 210 may use the scheduler 246 to schedule one or more UEs 220 for downlink or uplink communications. In some aspects, the scheduler 246 may use DCI to dynamically schedule DL transmissions to the UE 220 and/or UL transmissions from the UE 220. In some examples, the scheduler 246 may allocate recurring time domain resources and/or frequency domain resources that the UE 220 may use to transmit and/or receive communications using an RRC configuration (for example, a semi-static configuration), for example, to perform semi-persistent scheduling (SPS) or to configure a configured grant (CG) for the UE 220.

One or more of the transmit processor 214, the TX MIMO processor 216, the modem 232, the antenna 234, the MIMO detector 236, the receive processor 238, and/or the controller/processor 240 may be included in an RF chain of the network node 210. An RF chain may include filters, mixers, oscillators, amplifiers, analog-to-digital converters (ADCs), and/or other devices that convert between an analog signal (such as for transmission or reception on an air interface) and a digital signal (such as for processing by one or more processors of the network node 210). In some aspects, the RF chain may be or may be included in a transceiver of the network node 110.

In some examples, the network node 210 may use the communication unit 244 to communicate with a core network or other network nodes. The communication unit 244 may support wired and/or wireless communication protocols and/or connections such as Ethernet, optical fiber, common public radio interface (CPRI), and/or a wired or wireless backhaul, among other examples. The network node 210 may use the communication unit 244 to transmit and/or receive data associated with the UE 220 or to perform network control signaling, among other examples. The communication unit 244 may include a transceiver and/or an interface such as a network interface.

The UE 220 may include a set of antennas 252 (shown as antennas 252a through 252r, where r≥1), a set of modems 254 (shown as modems 254a through 254r, where r≥1), a MIMO detector, a receive processor 258, a data sink 260, a data source 262, a transmit processor 264, a TX MIMO processor 266, a controller/processor 280, a memory 282, and/or a communication manager 140, among other examples. One or more of the components of the UE 220 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 220.

The transceiver may be used by a processor (for example, the controller/processor 280) and the memory 282 to perform aspects of any of the methods described herein. The term “controller/processor” may refer to one or more controllers and/or one or more processors. For example, reference to “a/the processor” or “a/the controller/processor” (in the singular) should be understood to refer to any one or more of the processors described in connection with FIG. 2 (for example, a single processor or a combination of multiple different processors). Similarly, reference to “a/the memory” should be understood to refer to any one or more memories of the corresponding device or node (for example, a single memory or a combination of multiple different memories). In some aspects, the UE 220 may include another interface, another communication component, and/or another component that facilitates communication with the network node 210 and/or another UE 220.

One or more antennas of the set of antennas 252 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. In some examples, each of the antenna elements of an antenna 234 may include one or more sub-elements for radiating or receiving radio frequency signals. As used herein, “antenna” can refer to one or more antennas, one or more antenna panels, one or more antenna groups, one or more sets of antenna elements, or one or more antenna arrays.

For downlink communication, the set of antennas 252 may receive the downlink communications or signals from the network node 210 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 220 to a data sink 260 (such as data a data pipeline, a data queue, or an application executed on the UE 220), and may provide decoded control information and system information to a controller/processor 280.

For uplink communication, the transmit processor 264 may receive and process data (“uplink data”) from a data source 262 (such as data a data pipeline, a data queue, or an application executed on the UE 220) and control information from the controller/processor 280. The control information may include one or more parameters, feedback, one or more signal measurements, and/or other types of control information. In some aspects, the receive processor 258 and/or the controller/processor 280 may determine one or more parameters for a received signal (such as received from the network node 210 or another UE), such as an RSRP parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, and/or another parameter. The control information may facilitate parameter selection and/or scheduling for the UE 220 by the network node 210.

The transmit processor 264 may generate reference symbols for one or more reference signals, such as an uplink DMRS, an uplink SRS, and/or another type of reference signal. The symbols from the transmit processor 264 may be precoded by the TX MIMO processor 266 if applicable, further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, R output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, or upconvert) the output sample stream to obtain an uplink signal.

The modems 254a through 254r may transmit a set of uplink signals (for example, R downlink signals) via the corresponding set of antennas 252. An uplink signal may include an uplink control information (UCI) communication, a MAC-CE communication, an RRC communication or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), or a physical sidelink feedback channel (PSFCH).

In some examples, the uplink communication or the downlink communication may include a MIMO communication. “MIMO” generally refers to transmitting and receiving multiple data signals (such as multiple layers or multiple data streams) simultaneously over a radio channel. MIMO may exploit multipath propagation. MIMO may be implemented using spatial processing referred to as precoding, or using spatial multiplexing. In some examples, MIMO may support simultaneous transmission to multiple receivers, referred to as multi-user MIMO (MU-MIMO). Some RATs may employ advanced MIMO techniques, such as multiple TRP operation (including redundant transmission or reception on multiple TRPs), reciprocity in the time domain or the frequency domain, single-frequency-network (SFN) transmission, or non-coherent joint transmission (NC-JT).

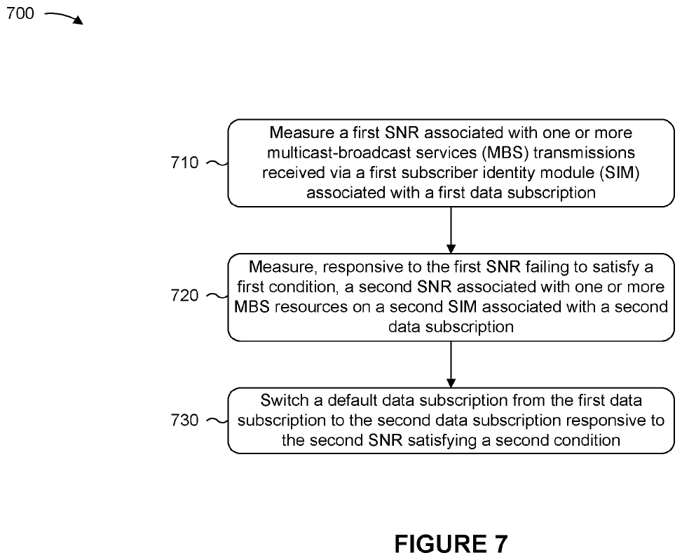

The controller/processor 240 of the network node 210, the controller/processor 280 of the UE 220, or any other component(s) of FIG. 2 may implement one or more techniques or perform one or more operations associated with default data subscription selection for MBS, as described in more detail elsewhere herein. For example, the controller/processor 240 of the network node 210, the controller/processor 280 of the UE 220, or any other component(s) of FIG. 2 may perform or direct operations of, for example, process 700 of FIG. 7 or other processes as described herein. The memory 242 and the memory 282 may store data and program codes for the network node 210 and the UE 220, respectively. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 210 or the UE 220, may cause the one or more processors to perform process 700 of FIG. 7 or other processes as described herein. In some examples, executing instructions may include running the instructions, converting the instructions, compiling the instructions, or interpreting the instructions, among other examples.

In some aspects, the UE 120 includes means for measuring a first SNR associated with one or more MBS transmissions received via a first SIM associated with a first data subscription; means for measuring, responsive to the first SNR failing to satisfy a first condition, a second SNR associated with one or more MBS resources on a second SIM associated with a second data subscription; and/or means for switching a default data subscription from the first data subscription to the second data subscription responsive to the second SNR satisfying a second condition. The means for the UE 120 to perform operations described herein may include, for example, communication manager 140, antenna 252, modem 254, MIMO detector 256, receive processor 258, transmit processor 264, TX MIMO processor 266, controller/processor 280, and/or memory 282.

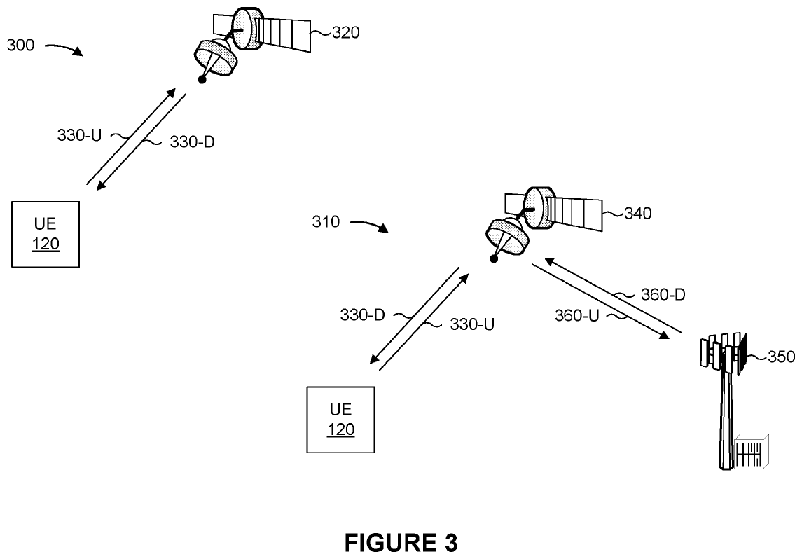

FIG. 3 is a diagram illustrating examples of satellite deployments in an NTN in accordance with the present disclosure. In particular, FIG. 3 illustrates an example 300 of a regenerative satellite deployment in an NTN, and an example 310 of a transparent satellite deployment in an NTN.

Example 300 shows a regenerative satellite deployment in an NTN. In example 300, a UE 120 is served by a satellite 320 via a service link 330. For example, the satellite 320 may include a network node 110. The satellite 320 may be referred to as a non-terrestrial network node, a non-terrestrial base station, a regenerative repeater, and/or an on-board processing repeater, among other examples. The satellite 320 may demodulate an uplink radio frequency (RF) signal and may modulate a baseband signal derived from the uplink RF signal to produce a downlink RF transmission. The satellite 320 may transmit the downlink RF signal to the UE 120 on the service link 330. The satellite 320 may provide a cell that covers the UE 120.

Example 310 shows a transparent satellite deployment, which may also be referred to as a bent-pipe satellite deployment. In example 310, a UE 120 is served by a satellite 340 via the service link 330. The satellite 340 may be a transparent satellite. The satellite 340 may relay a signal received from a gateway 350 (for example, a reference point) via a feeder link 360. For example, the satellite 340 may receive an RF transmission from the gateway 350 via the feeder link 360 and may relay the RF transmission to the UE 120 via the service link 330 without demodulating the RF transmission. Additionally or alternatively, the satellite 340 may receive an RF transmission from the UE 120 via the service link 330 and may relay the RF transmission to the gateway 350 via the feeder link 360 without demodulating the RF transmission. The satellite 340 may frequency convert the RF transmission(s) received on the service link 330 to a frequency of the RF transmission(s) on the feeder link 360 (or vice versa) and may amplify and/or filter the relayed RF transmission(s). The UEs 120 shown in example 300 and example 310 may be associated with a GNSS capability or a Global Positioning System (GPS) capability, though not all UEs have such capabilities. The satellite 340 may provide a cell that covers the UE 120.

As shown in FIG. 3, the service link 330 may include a link between the satellite 320/340 and the UE 120, and may include one or more of an uplink or a downlink. The feeder link 360 may include a link between the satellite 340 and the gateway 350, and may include one or more of an uplink (for example, from the UE 120 to the gateway 350 via the satellite 340) or a downlink (for example, from the gateway 350 to the UE 120 via the satellite 340). As shown in FIG. 3, an uplink of the service link 330 is indicated by reference number 330-U and a downlink of the service link 330 is indicated by reference number 330-D. Similarly, an uplink of the feeder link 360 is indicated by reference number 360-U and a downlink of the feeder link 360 is indicated by reference number 360-D.

The feeder link 360 and the service link 330 may each experience Doppler effects due to the movement of the satellites 320 and 340, and potentially movement of a UE 120. The Doppler effects may be significantly larger than in a terrestrial network. The Doppler effect on the feeder link 360 may be compensated for to some degree, but may still be associated with some amount of uncompensated frequency error. Furthermore, the gateway 350 may be associated with a residual frequency error, and/or the satellite 320/340 may be associated with an on-board frequency error. These sources of frequency error may cause a received downlink frequency at the UE 120 to drift from a target downlink frequency. Furthermore, due to the long distance between the UE 120 and the satellite 320/340, communication in an NTN may be associated with a much longer delay (for example, a longer latency and/or a longer round-trip time (RTT)) than a delay associated with a terrestrial network. The delay may be even greater in a transparent satellite deployment because any communication between the UE 120 and the gateway 350 must travel over the service link 330 and the feeder link 360, each of which may associated with a longer delay than a terrestrial network. Furthermore, a beam associated with the satellite 320/340 may cover a very large area, which can result in significant SNR fluctuation within the coverage area of the satellite beam (for example, due to variations in a propagation environment, local interference, mobility, and/or hardware capabilities of devices within the coverage area, among other examples).

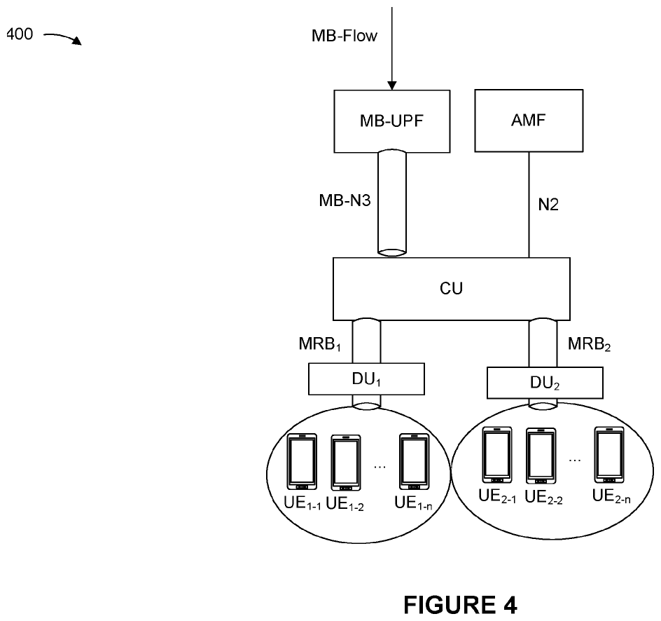

FIG. 4 is a diagram illustrating an example of an MBS architecture 400 in accordance with the present disclosure. In some examples, the MBS architecture 400 may be deployed in a wireless network (for example, wireless network 100) to support multicast services and/or broadcast services to simultaneously disseminate data, such as emergency alerts or audio or video content, among many other possibilities, to multiple UEs 120 that may be located in the same or different cells. In general, because multicast and/or broadcast operations enable multiple UEs 120 to receive the same data at substantially the same time, multicast and/or broadcast (“multicast-broadcast”) operations can significantly reduce network overhead relative to unicast operations in which a particular transmission is intended for and received by only one UE.

In some examples, an MBS transmission may be a multicast transmission or a broadcast transmission that is transmitted to multiple UEs 120. In some cases, a multicast transmission may be a transmission of the same information or content to multiple (for example, a set) UEs 120. In some cases, each of the UEs 120 may need to join a multicast session prior to receiving information using the multicast communication. For example, the UEs 120 may join the multicast session using non-access stratum (NAS) based signaling. In some cases, the UEs 120 may need to be authorized, or authenticated, prior to joining the multicast session. For example, a network node 110 may indicate to a UE 120, of the set of UEs 120, whether the UE 120 is authorized or authenticated prior to the UE 120 joining the multicast session and receiving information via a multicast transmission. In some cases, not all of the UEs 120 within an area (for example, a multicast service area) may receive the information via the multicast transmission. For example, the network node 110 may transmit the information to a subset of the UEs 120, of the set of UEs 120, within the multicast service area. In some cases, a UE 120 in the multicast service area that has not been authorized or authenticated may not receive the information via the multicast transmission. In some cases, the network node 110 is aware of whether or not individual UEs 120, of the set of UEs 120, have received the information using the multicast transmission. In some cases, the multicast transmission may be referred to as a “one-to-many” transmission.

Additionally or alternatively, a broadcast transmission may be a transmission of the same information or content to all UEs 120 within an area (for example, a broadcast service area). The UEs 120 may not need to join a session prior to receiving the information using the broadcast communication. For example, the UEs 120 do not need to access a session using NAS based signaling prior to receiving the information using the broadcast communication. In some cases, the UEs 120 may not need to be authorized, or authenticated, prior to receiving information via a broadcast transmission. In some cases, a UE 120 may receive a broadcast transmission in an RRC idle state, an RRC inactive state, and/or an RRC connected state. In some cases, the network node 110 may transmit the information to all of the UEs 120 within the broadcast service area. For example, the network node 110 may be unable to broadcast the information to only a subset of the UEs 120. In some cases, the network node 110 may not be aware of whether or not individual UEs 120, of the set of UEs 120, have received the information using the broadcast transmission. In some cases, the broadcast transmission may be referred to as a “one-to-all” communication.

In a wireless network, MBS operations may be supported using enhanced multimedia broadcast/multicast service (eMBMS), single-cell point-to-multipoint (SC-PTM) services, multimedia broadcast multicast service over single frequency network (MBSFN), or enhanced TV (EnTV), among other examples. For example, in eMBMS, multicast data is transmitted in multiple cells to a group of UEs 120 located in a particular area. In SC-PTM, multicast data is transmitted in a particular cell and the multicast data is received by a group of UEs 120 that are located in the particular cell. In an NR network, a UE 120 may receive multicast broadcast services in mixed mode or broadcast mode. For example, in mixed mode, a UE in an RRC connected mode may receive multicast broadcast service using a multicast broadcast radio bearer (MRB) or a dedicated radio bearer (DRB). In broadcast mode, a UE 120 may receive MBS using an MRB in an RRC connected mode, an RRC idle mode, or an RRC inactive mode.

As shown in FIG. 4, the MBS architecture 400 may include a multicast broadcast user plane function (MB-UPF) that receives (for example, from an application server) a multicast broadcast (MB) flow including content to be multicasted or broadcasted. As further shown, the multicast broadcast service architecture may include a CU that receives the MB flow and a temporary mobile group identity (TMGI) associated with the MB flow from the MB-UPF over an MB-N3 tunnel (for example, a user plane interface for delivering the MB flow and the corresponding TMGI using a general packet radio service tunneling protocol (GTP)). Furthermore, the CU may communicate with an access and mobility management function (AMF) that manages UE network registration, manages mobility, maintains NAS signaling connections, or manages UE registration procedures, among other examples. For example, the CU may communicate with the AMF over an N2 interface that enables control signaling to establish or modify the MB flow or the TMGI.

In some examples, the CU may map the MB flow received from the MB-UPF to an MRB or a DRB based at least in part on the TMGI associated with the MB flow, and the CU may forward the MB flow to a DU that may include or control one or more TRPs or RUs, which may multicast or broadcast the content included in the MB flow to one or more UEs 120 via an MRB. Additionally or alternatively, the DU may transmit the content included in the MB flow or may cause the content included in the MB flow to be transmitted to one or more UEs 120 via a DRB. In this way, the MBS architecture 400 may flexibly switch between transmitting content to UEs 120 via a DRB (or a unicast bearer) and an MRB, and may provide unicast assistance to the MRB at lower layers to improve reliability or reduce service disruption.

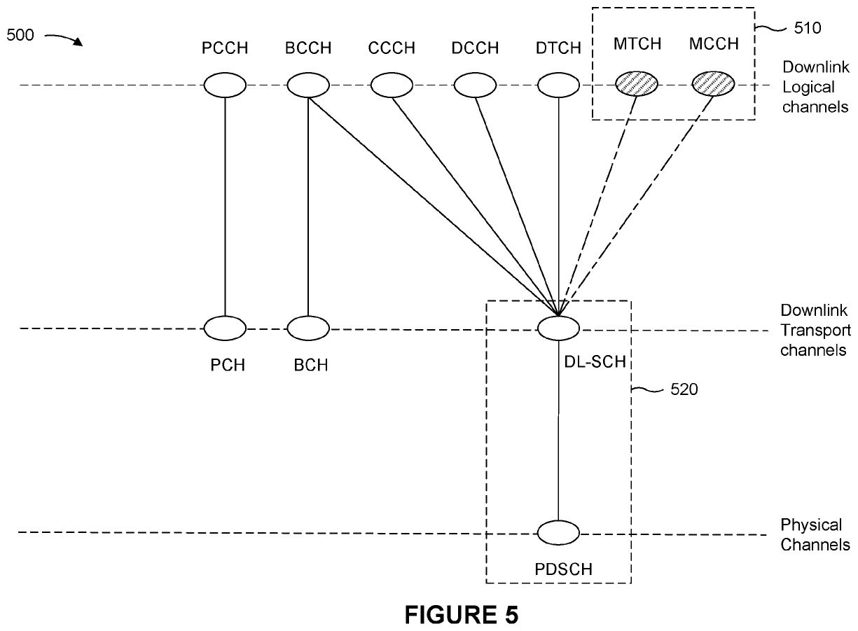

FIG. 5 is a diagram illustrating an example of a channel mapping 500 for MBS communications in accordance with the present disclosure. As shown by MBS channels 510, multicast or broadcast transmissions in an NR network may be supported using a multicast broadcast traffic channel (MTCH) and a multicast broadcast control channel (MCCH). The MTCH may carry multicast or broadcast data, while the MCCH may carry configuration information or control information for multicast or broadcast communications to be transmitted on the MTCH. An MBS communication on the MTCH may be addressed to a group of UEs using a group common radio network temporary identifier (G-RNTI).

In some examples, different MTCHs may be used to carry multicast broadcast traffic with different quality of service (QOS) requirements. A multicast broadcast traffic flow with associated QoS requirements or QoS parameters (for example, a group of related packets for the same multicast broadcast service) may be referred to as an MB-QOS flow. In some examples, there may be a one-to-one mapping between MB-QoS flows and MTCHs. A network node or a core network device may configure an MRB for an MB-QoS flow. In some examples, there may be a one-to-one mapping between MB-QoS flows and MRBs. Accordingly, each MTCH may correspond to an MRB for carrying an MB-QOS flow.

The MCCH may carry configuration information for configuring the MTCHs, and may be addressed to all UEs in a cell (for example, a physical cell or a virtual cell) using a single cell RNTI (SC-RNTI). In some examples, there may be a single MCCH per cell (physical cell or virtual cell), and the MCCH may carry MTCH configuration information for multiple multicast broadcast services with different MB-QOS flows. As shown by channel mapping 520, the MCCH and the MTCH are logical channels, and may be mapped to a downlink shared channel (DL-SCH) transport channel, which may be mapped to a PDSCH.

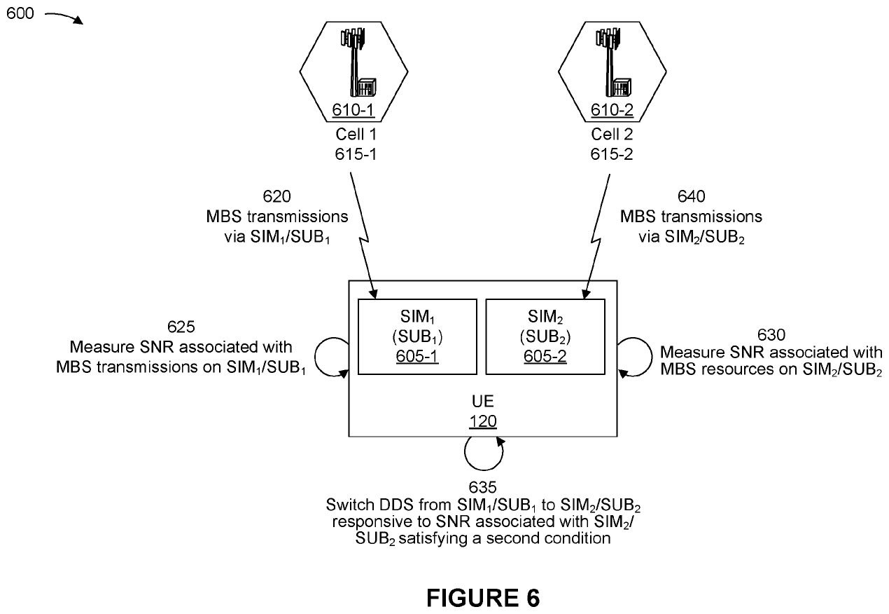

FIG. 6 is a diagram illustrating an example 600 associated with default data subscription selection for MBS in accordance with the present disclosure. As shown in FIG. 6, a UE 120 may be a multiple SIM (multi-SIM) UE that includes multiple SIMs, including a first SIM 605-1 (shown as SIM1) and a second SIM 605-2 (shown as SIM2). In some aspects, as described herein, the first SIM 605-1 may be associated with a first data subscription (shown as SUB1), and the second SIM 605-2 may be associated with a second data subscription (shown as SUB2). As described herein, a data subscription may be a data subscription with an MNO that enables the UE 120 to access a wireless network (for example, a RAN) associated with the MNO. For example, in some aspects, the first data subscription and the second data subscription may be associated with different MNOs, or may be associated with different account or service tiers for the same MNO.

In some aspects, a SIM 605 may be a removable SIM (for example, a SIM card) or an embedded SIM. A SIM 605 may include an integrated circuit that securely stores an international mobile subscriber identity (IMSI) and a security key, which are used to identify and authenticate a corresponding data subscription associated with the SIM 605. In some cases, a SIM 605 may store a list of services that the UE 120 has permission to access using a data subscription associated with the SIM 605, such as a data service or a voice service, among other examples.

As further shown in FIG. 6, the UE 120 may communicate (for example, in an RRC connected mode, an RRC idle mode, or an RRC inactive mode) with a first network node 610-1 via a first cell 615-1 (shown as Cell 1) using the first SIM 605-1. In this case, a first subscription (SUB1) of the UE 120 may be used to access the first cell 615-1 (for example, using a first IMSI for UE identification, using a first security key for UE authentication, using a first list of services that the UE 120 is permitted to access using the first data subscription, or by counting data or voice usage on the first cell against the first subscription, among other examples). Similarly, the UE 120 may communicate (for example, in an RRC connected mode, an RRC idle mode, or an RRC inactive mode) with a second network node 610-2 via a second cell 615-2 (shown as Cell 2) using the second SIM 605-2. In this case, a second subscription (SUB2) of the UE 120 may be used to access the second cell 615-2 (for example, using a second IMSI for UE identification, using a second security key for UE authentication, using a second list of services that the UE 120 is permitted to access using the second data subscription, or by counting data or voice usage on the second cell against the second data subscription).

The first network node 610-1 and/or the second network node 610-2 may include one or more of the network nodes 110 described herein. Although the first cell 615-1 and the second cell 615-2 are shown as being provided by different network nodes 610-1 and 610-2, in some aspects, the first cell 615-1 and the second cell 615-2 may be provided by the same network node. Thus, in some aspects, the first network node 610-1 and the second network node 610-2 may be integrated into a single network node 610.

In some cases, the UE 120 may be capable of operating in a multi-SIM multiple standby (MSMS) mode, such as a dual SIM dual standby (DSDS) mode (for example, when the UE 120 is associated with two data subscriptions). Additionally or alternatively, the UE 120 may be capable of operating in a multi-SIM multiple active (SR-MSMA) mode, such as a dual SIM dual active (DSDA) mode (for example, when the UE 120 is associated with two data subscriptions).

In a DSDA mode, the UE 120 is capable of concurrent active communication using both SIMs 605-1 and 605-2. Thus, a UE 120 in the DSDA mode is capable of communicating using the first SIM 605-1 (and the first data subscription) at the same time as communicating using the second SIM 605-2 (and the second data subscription). For example, when the UE 120 is in an active session (for example, a voice call or another latency sensitive service, such as online gaming, stock trading, or an over-the-top (OTT) service) using the first SIM 605-1, the UE 120 is capable of receiving a notification of a voice call using the second SIM 605-2 without interrupting communications that use the first SIM 605-1, and without tuning or switching away from the first cell 615-1 to tune to the second cell 615-2.

In a DSDS mode, the UE 120 is not capable of concurrent active communication using both SIMs of the UE 120. Thus, a UE 120 in the DSDS mode is not capable of communicating using the first SIM 605-1 (and the first data subscription) at the same time as communicating using the second SIM 605-2 (and the second data subscription). However, a UE 120 in the DSDS mode may be capable of switching between two separate mobile network services, may include hardware for maintaining multiple connections (for example, one connection per SIM) in a standby state, or may include hardware (for example, multiple transceivers) for maintaining multiple network connections at the same time, among other examples. However, a UE 120 in the DSDS mode may be capable of receiving data on only one connection at a time because RF resources are shared between the multiple subscriptions. For example, a UE 120 in the DSDS mode may be associated with multiple data subscriptions but may include only a single transceiver shared by the multiple data subscriptions, a single transmit chain shared by the multiple data subscriptions, or a single receive chain shared by the multiple data subscriptions, among other examples.

In some examples, a UE 120 may be capable of operating in a DSDA mode for a first combination of RATs, and may not be capable of operating in a DSDA mode for a second combination of RATs. For example, the UE 120 may be capable of operating in a DSDA mode for NR+NR, where the first cell 615-1 (as well as the first SIM 605-1 and the first data subscription) uses an NR RAT and the second cell 615-2 (as well as the second SIM 605-2 and the second data subscription) also uses the NR RAT. However, the UE 120 may not be capable of operating in a DSDA mode for NR+LTE, where one of the first cell 615-1 (as well as the first SIM 605-1 and the first data subscription) uses an NR RAT and the second cell 615-2 (as well as the second SIM 605-2 and the second data subscription) uses an LTE RAT (or vice versa). In some aspects, the UE 120 may not be capable of operating in the DSDA mode for the second combination of RATs (for example, NR+LTE), but be capable of operating in a DSDS mode for the second combination of RATs. This design of the UE 120 reduces design costs as compared to enabling the UE 120 to operate using the DSDA mode for the second combination of RATs.

As described herein, various aspects relate generally to techniques that the multi-SIM UE 120 may implement to enable fast corrective action to improve performance for MBS when one or more conditions are satisfied, without having to wait for, or otherwise rely upon, a wireless network to correct issues that may be degrading MBS performance. For example, in a first operation 620, the UE 120 may receive one or more MBS transmissions from the first cell 615-1 via the first data subscription associated with the first SIM 605-1. For example, the MBS transmissions received from the first cell 615-1 may be communicated to the UE 120 using the MBS architecture 400 shown in FIG. 4, using the channel mapping shown in FIG. 5, and/or using any other suitable technique(s) described in more detail elsewhere herein. In some cases, the UE 120 may be configured to receive the MBS transmissions in a receive-only mode, where the UE 120 can receive the MBS transmissions but cannot transmit any information (for example, such as feedback or performance measurements) to the network node 610-1 associated with the first cell 615-1. Additionally or alternatively, the first cell 615-1 may be provided in an NTN or a terrestrial network in which there is significant SNR fluctuation within the coverage area of the first cell 615-1 and one or more conditions (for example, large propagation delays or interference) prevent the UE 120 from reporting SNR or other performance metrics associated with the MBS transmissions in real-time.

Accordingly, in a second operation 625, the UE 120 may measure an SNR associated with the MBS transmissions that are received from the first cell 615-1 via the first SIM 605-1. For example, in some aspects, the UE 120 may measure the SNR associated with the MBS transmissions received via the first SIM 605-1 to detect when MBS reception is underperforming on the first SIM 605-1. For example, in some aspects, the UE 120 may determine that MBS reception is underperforming on the first SIM 605-1 when the SNR associated with the MBS transmissions received via the first SIM 605-1 fail to satisfy a first condition, such as failing to satisfy (for example, failing to equal or exceed) a threshold. In some aspects, the threshold may be a configurable value that is defined at an original equipment manufacturer (OEM) level, and may be stored in an encrypted file system (EFS) file on the UE 120 (for example, in a memory of the UE 120). Additionally or alternatively, the threshold may be configurable by a wireless network and/or updated by an MNO associated with the first data subscription. Furthermore, in some aspects, the UE 120 may determine that the SNR associated with the MBS transmissions received via the first SIM 605-1 fail to satisfy the first condition responsive to the SNR failing to satisfy the threshold for at least a threshold time duration. For example, to prevent the UE 120 from consuming resources (for example, processing, memory, and/or power) by obtaining measurements on the second SIM 605-2 due to transient decreases in SNR measurements, the UE 120 may start a timer when the SNR associated with the MBS transmissions received via the first SIM 605-1 fail to satisfy the threshold, and may determine that the SNR associated with the MBS transmissions received via the first SIM 605-1 fail to satisfy the first condition responsive to the SNR continuing to fail to satisfy the threshold until the timer expires.

In some aspects, in a third operation 630, the UE 120 may measure one or more MBS resources on the second SIM 605-2 associated with the second (inactive) data subscription. For example, in some aspects, the UE 120 may measure the one or more MBS resources on the second SIM 605-2 associated with the second data subscription responsive to the SNR associated with the MBS transmissions received via the first SIM 605-1 failing to satisfy the first condition (for example, failing to satisfy a threshold and/or failing to satisfy the threshold for a threshold duration). Furthermore, in some aspects, the UE 120 measure the one or more MBS resources on the second SIM 605-2 responsive to determining that the MBS resources on the second SIM 605-2 support reception of MBS transmissions associated with the same service identifier and/or TMGI as the MBS transmissions being received via the first SIM 605-1.

For example, in some aspects, an OEM associated with the UE 120 may provision the UE 120 with a database (for example, at manufacture time or using downloaded or OTA software updates), which may indicate, for each data subscription associated with the UE 120, each MBS frequency that supports a particular service identifier or TMGI in a given service area. For example, in some aspects, the database may include information that indicates, for the first data subscription, a set of MBS service identifiers and/or TMGIs that are supported on the second data subscription and a set of corresponding MBS frequencies associated with the supported MBS service identifiers and/or TMGIs, and the database may include similar information for the second data subscription. In some aspects, the database provisioned by the OEM may be updated (for example, using downloaded or OTA software updates) to indicate one or more changes to the MBS frequencies that are available in one or more areas. Additionally or alternatively, one or more network nodes 610 (for example, network node 610-1 and/or network node 610-2) may transmit signaling to the UE 120 that indicates one or more neighbor cells and/or operator frequencies that support MBS associated with one or more service identifiers and/or TMGIs that are mapped to the UE 120. In this way, information stored by and maintained by the UE 120 (for example, in the database provisioned to the UE 120 and/or the signaling provided by the network node(s) 610) may allow the UE 120 to determine one or more neighboring cells and/or frequencies that support the same MBS stream, service identifier, and/or TMGI associated with the MBS transmissions being received via the first SIM 605-1. Furthermore, in some aspects, the information stored by and maintained by the UE 120 may be provided for one or more NTNs and/or one or more terrestrial networks and/or for different MNO PLMNs (for example, subject to roaming agreements between the different MNOs). In this way, responsive to the UE 120 determining that the SNR associated with the MBS transmissions being received via the first SIM 605-1 fail to satisfy the first condition, the UE 120 may measure the MBS resources associated with the second SIM 605-2 responsive to the information stored and maintained by the UE 120 indicating that the MBS resources associated with the second SIM 605-2 support the same stream, service identifier, and/or TMGI associated with the MBS transmissions being received via the first SIM 605-1. Furthermore, in some aspects, the information that indicates the one or more MBS frequencies that are associated with respective TMGIs and/or service identifiers may be ordered or prioritized (for example, by a network node 610 or the OEM) based on one or more metrics that provide visibility into MBS performance within the corresponding service area.

As further shown in FIG. 6, in a fourth operation 635, the UE 120 may switch a default data subscription (for example, a current or active data subscription) from the first SIM 605-1 to the second SIM 605-2 responsive to a second condition being satisfied. For example, as described herein, the UE 120 may generally measure the MBS resources on the second SIM 605-2 responsive to the SNR associated with the MBS transmissions received via the first SIM 605-1 failing to satisfy a first condition and further responsive to the MBS resources on the second SIM 605-2 supporting the same stream, service identifier, and/or TMGI associated with the MBS transmissions being received via the first SIM 605-1. In the fourth operation 635, the UE 120 may then switch the default data subscription, making the second data subscription the current or active data subscription, based on the SNR associated with the MBS resources on the second SIM 605-2 satisfying a second condition. For example, in some aspects, the SNR associated with the MBS resources on the second SIM 605-2 may satisfy the second condition responsive to the SNR satisfying (for example, equaling or exceeding) a threshold, which may be configured in a similar manner as described above for the first data subscription. Furthermore, in some aspects, the UE 120 may determine that the SNR associated with the MBS resources on the second SIM 605-2 satisfy the second condition responsive to the SNR satisfying the threshold for a threshold duration (for example, after expiration of a timer that is started when the SNR measurement associated with the MBS resources on the second SIM 605-2 initially satisfy the applicable threshold).

In some aspects, in a fifth operation 640, the UE 120 may then start to receive MBS transmissions from the second cell 615-2 via the second SIM 605-2 associated with the second data subscription. For example, when the UE 120 switches the default (for example, current or active) data subscription to the second data subscription, the UE 120 may select the second cell 615-2 associated with the second data subscription responsive to the second cell 615-2 satisfying one or more criteria (for example, having a highest SNR measurement and/or a lowest interference measurement, among other examples). In this way, the UE 120 may select the second cell 615-2 from a set of candidate cells associated with the second data subscription that offers the best MBS performance to improve MBS service continuity. Furthermore, after switching the default data subscription to the second data subscription, the UE 120 may start a timer and may maintain the second data subscription as the default data subscription at least until the timer expires (for example, to prevent the UE 120 from ping-ponging between the first data subscription and the second data subscription). In such cases, after the timer has expired, the UE 120 may apply similar logic to determine whether and/or when to select the first data subscription as the default data subscription. For example, responsive to the SNR associated with the MBS transmissions received via the second SIM 605-2 failing to satisfy the first condition (for example, failing to satisfy a threshold for a threshold duration), the UE 120 may measure an SNR associated with MBS resources on the first SIM 605-1 that support the same MBS stream, service identifier, or TMGI, and may switch the default data subscription back to the first data subscription responsive to the SNR associated with MBS resources on the first SIM 605-1 satisfying a second condition (for example, satisfying a threshold for a threshold duration).

FIG. 7 is a flowchart illustrating an example process 700 performed, for example, by a UE that supports default data subscription selection for MBS in accordance with the present disclosure. Example process 700 is an example where the UE (for example, UE 120) performs operations associated with default data subscription selection for MBS.

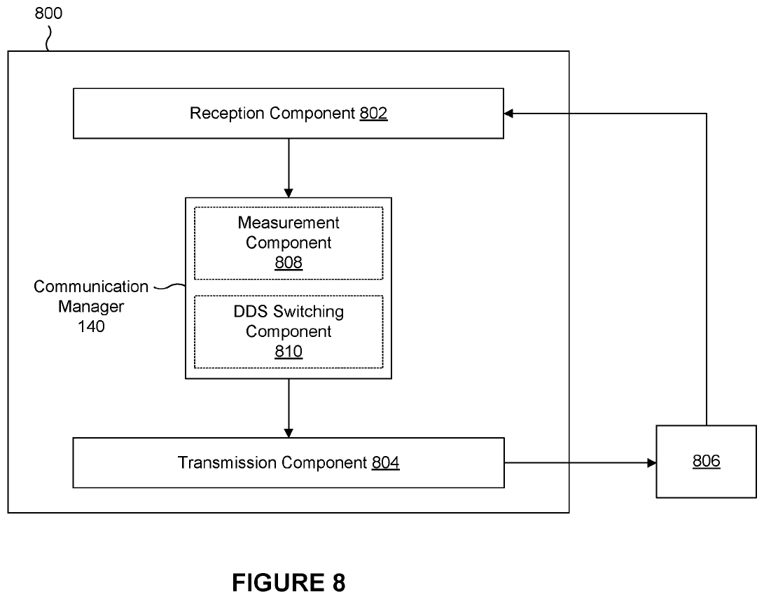

As shown in FIG. 7, in some aspects, process 700 may include measuring a first SNR associated with one or more MBS transmissions received via a first SIM associated with a first data subscription (block 710). For example, the UE (such as by using communication manager 140 or measurement component 808, depicted in FIG. 8) may measure a first SNR associated with one or more MBS transmissions received via a first SIM associated with a first data subscription, as described above.

As further shown in FIG. 7, in some aspects, process 700 may include measuring, responsive to the first SNR failing to satisfy a first condition, a second SNR associated with one or more MBS resources on a second SIM associated with a second data subscription (block 720). For example, the UE (such as by using communication manager 140 or measurement component 808, depicted in FIG. 8) may measure, responsive to the first SNR failing to satisfy a first condition, a second SNR associated with one or more MBS resources on a second SIM associated with a second data subscription, as described above.

As further shown in FIG. 7, in some aspects, process 700 may include switching a default data subscription from the first data subscription to the second data subscription responsive to the second SNR satisfying a second condition (block 730). For example, the UE (such as by using communication manager 140 or default data subscription (DDS) switching component 810, depicted in FIG. 8) may switch a default data subscription from the first data subscription to the second data subscription responsive to the second SNR satisfying a second condition, as described above.

Process 700 may include additional aspects, such as any single aspect or any combination of aspects described below or in connection with one or more other processes described elsewhere herein.

In a first additional aspect, process 700 includes receiving one or more subsequent MBS transmissions via the second SIM associated with the second data subscription responsive to switching the default data subscription from the first data subscription to the second data subscription.

In a second additional aspect, alone or in combination with the first aspect, the first SNR fails to satisfy the first condition responsive to the first SNR failing to satisfy a threshold value.

In a third additional aspect, alone or in combination with one or more of the first and second aspects, the first SNR fails to satisfy the first condition responsive to the first SNR failing to satisfy the threshold value for a threshold duration.

In a fourth additional aspect, alone or in combination with one or more of the first through third aspects, the second SNR satisfies the second condition responsive to the second SNR satisfying a threshold value.

In a fifth additional aspect, alone or in combination with one or more of the first through fourth aspects, the second SNR satisfies the second condition responsive to the second SNR satisfying the threshold value for a threshold duration.

In a sixth additional aspect, alone or in combination with one or more of the first through fifth aspects, process 700 includes starting a timer responsive to switching the default data subscription from the first data subscription to the second data subscription, and maintaining the second data subscription as the default data subscription at least until the timer expires.

In a seventh additional aspect, alone or in combination with one or more of the first through sixth aspects, switching the default data subscription includes selecting, among one or more cells associated with the second data subscription that support MBS, an available cell satisfying one or more criteria.

In an eighth additional aspect, alone or in combination with one or more of the first through seventh aspects, process 700 includes storing or maintaining information that indicates one or more MBS frequencies for the first data subscription and one or more MBS frequencies for the second data subscription, wherein the second SNR is measured responsive to the information indicating that the one or more MBS frequencies for the second data subscription support a service or a stream associated with the one or more MBS transmissions received via the first SIM.

In a ninth additional aspect, alone or in combination with one or more of the first through eighth aspects, the information that indicates the one or more MBS frequencies for the first data subscription includes one or more service identifiers or TMGIs associated with the one or more MBS frequencies for the first data subscription, and wherein the information that indicates the one or more MBS frequencies for the second data subscription includes one or more service identifiers or TMGIs associated with the one or more MBS frequencies for the second data subscription.

In a tenth additional aspect, alone or in combination with one or more of the first through ninth aspects, the information that indicates the one or more MBS frequencies for the first data subscription and the one or more MBS frequencies for the second data subscription is configured by an OEM.

In an eleventh additional aspect, alone or in combination with one or more of the first through tenth aspects, process 700 includes receiving, from a network node, the information that indicates the one or more MBS frequencies for the first data subscription and the one or more MBS frequencies for the second data subscription.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports default data subscription selection for MBS in accordance with the present disclosure.

The apparatus 800 may be a UE, or a UE may include the apparatus 800. In some aspects, the apparatus 800 includes a reception component 802, a transmission component 804, and a communication manager 140, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to and/or operable to perform one or more operations described herein in connection with FIG. 6. Additionally or alternatively, the apparatus 800 may be configured to and/or operable to perform one or more processes described herein, such as process 700 of FIG. 7. In some aspects, the apparatus 800 may include one or more components of the UE described above in connection with FIG. 2.

The reception component 802 may receive communications, such as reference signals, control information, and/or data communications, from the apparatus 806. The reception component 802 may provide received communications to one or more other components of the apparatus 800, such as the communication manager 140. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, a modem, a demodulator, a MIMO detector, a receive processor, a controller/processor, and/or a memory of the UE described above in connection with FIG. 2.

The transmission component 804 may transmit communications, such as reference signals, control information, and/or data communications, to the apparatus 806. In some aspects, the communication manager 140 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, and/or a memory of the UE described above in connection with FIG. 2. In some aspects, the transmission component 804 may be co-located with the reception component 802 in a transceiver.

The communication manager 140 may measure a first SNR associated with one or more MBS transmissions received via a first SIM associated with a first data subscription. The communication manager 140 may measure, responsive to the first SNR failing to satisfy a first condition, a second SNR associated with one or more MBS resources on a second SIM associated with a second data subscription. The communication manager 140 may switch a default data subscription from the first data subscription to the second data subscription responsive to the second SNR satisfying a second condition. In some aspects, the communication manager 140 may perform one or more operations described elsewhere herein as being performed by one or more components of the communication manager 140.

The communication manager 140 may include a controller/processor and/or a memory of the UE described above in connection with FIG. 2. In some aspects, the communication manager 140 includes a set of components, such as a measurement component 808 and/or a DDS switching component 810. Alternatively, the set of components may be separate and distinct from the communication manager 140. In some aspects, one or more components of the set of components may include or may be implemented within a controller/processor and/or a memory of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The measurement component 808 may measure a first SNR associated with one or more MBS transmissions received via a first SIM associated with a first data subscription. The measurement component 808 may measure, responsive to the first SNR failing to satisfy a first condition, a second SNR associated with one or more MBS resources on a second SIM associated with a second data subscription. The DDS switching component 810 may switch a default data subscription from the first data subscription to the second data subscription responsive to the second SNR satisfying a second condition.

The reception component 802 may receive one or more subsequent MBS transmissions via the second SIM associated with the second data subscription responsive to switching the default data subscription from the first data subscription to the second data subscription.

The DDS switching component 810 may start a timer responsive to switching the default data subscription from the first data subscription to the second data subscription. The DDS switching component 810 may maintain the second data subscription as the default data subscription at least until the timer expires.

The DDS switching component 810 may store or maintain information that indicates one or more MBS frequencies for the first data subscription and one or more MBS frequencies for the second data subscription, wherein the second SNR is measured responsive to the information indicating that the one or more MBS frequencies for the second data subscription support a service or a stream associated with the one or more MBS transmissions received via the first SIM.

The reception component 802 may receive, from a network node, the information that indicates the one or more MBS frequencies for the first data subscription and the one or more MBS frequencies for the second data subscription.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components.

Additionally or alternatively, a set of (one or more) components shown in FIG. 8 may perform one or more functions described as being performed by another set of components shown in FIG. 8.

The following provides an overview of some Aspects of the present disclosure:
Aspect 1: A method for wireless communication by a UE, comprising: measuring a first SNR associated with one or more MBS transmissions received via a first SIM associated with a first data subscription; measuring, responsive to the first SNR failing to satisfy a first condition, a second SNR associated with one or more MBS resources on a second SIM associated with a second data subscription; and switching a default data subscription from the first data subscription to the second data subscription responsive to the second SNR satisfying a second condition.
Aspect 2: The method of Aspect 1, further comprising: receiving one or more subsequent MBS transmissions via the second SIM associated with the second data subscription responsive to switching the default data subscription from the first data subscription to the second data subscription.
Aspect 3: The method of any of Aspects 1-2, wherein the first SNR fails to satisfy the first condition responsive to the first SNR failing to satisfy a threshold value.
Aspect 4: The method of Aspect 3, wherein the first SNR fails to satisfy the first condition responsive to the first SNR failing to satisfy the threshold value for a threshold duration.
Aspect 5: The method of any of Aspects 1-4, wherein the second SNR satisfies the second condition responsive to the second SNR satisfying a threshold value.
Aspect 6: The method of Aspect 5, wherein the second SNR satisfies the second condition responsive to the second SNR satisfying the threshold value for a threshold duration.
Aspect 7: The method of any of Aspects 1-6, further comprising: starting a timer responsive to switching the default data subscription from the first data subscription to the second data subscription; and maintaining the second data subscription as the default data subscription at least until the timer expires.
Aspect 8: The method of any of Aspects 1-7, wherein switching the default data subscription includes: selecting, among one or more cells associated with the second data subscription that support MBS, an available cell satisfying one or more criteria.
Aspect 9: The method of any of Aspects 1-8, further comprising: storing or maintaining information that indicates one or more MBS frequencies for the first data subscription and one or more MBS frequencies for the second data subscription, wherein the second SNR is measured responsive to the information indicating that the one or more MBS frequencies for the second data subscription support a service or a stream associated with the one or more MBS transmissions received via the first SIM.
Aspect 10: The method of Aspect 9, wherein the information that indicates the one or more MBS frequencies for the first data subscription includes one or more service identifiers or TMGIs associated with the one or more MBS frequencies for the first data subscription, and wherein the information that indicates the one or more MBS frequencies for the second data subscription includes one or more service identifiers or TMGIs associated with the one or more MBS frequencies for the second data subscription.
Aspect 11: The method of Aspect 9, wherein the information that indicates the one or more MBS frequencies for the first data subscription and the one or more MBS frequencies for the second data subscription is configured by an OEM.
Aspect 12: The method of Aspect 9, further comprising: receiving, from a network node, the information that indicates the one or more MBS frequencies for the first data subscription and the one or more MBS frequencies for the second data subscription.
Aspect 13: An apparatus for wireless communication at a device, comprising a processor; memory coupled with the processor; and instructions stored in the memory and executable by the processor to cause the apparatus to perform the method of one or more of Aspects 1-12.
Aspect 14: A device for wireless communication, comprising a memory and one or more processors coupled to the memory, the one or more processors configured to perform the method of one or more of Aspects 1-12.
Aspect 15: An apparatus for wireless communication, comprising at least one means for performing the method of one or more of Aspects 1-12.
Aspect 16: A non-transitory computer-readable medium storing code for wireless communication, the code comprising instructions executable by a processor to perform the method of one or more of Aspects 1-12.
Aspect 17: A non-transitory computer-readable medium storing a set of instructions for wireless communication, the set of instructions comprising one or more instructions that, when executed by one or more processors of a device, cause the device to perform the method of one or more of Aspects 1-12.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

Even though particular combinations of features are recited in the claims or disclosed in the specification, these combinations are not intended to limit the disclosure of various aspects.

Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories storing processor-executable code; and
one or more processors coupled with the one or more memories and individually or collectively configured to, when executing the processor-executable code, cause the UE to:
measure a first signal-to-noise ratio (SNR) associated with one or more multicast-broadcast services (MBS) transmissions received via a first subscriber identity module (SIM) associated with a first data subscription;
measure, responsive to the first SNR failing to satisfy a first condition, a second SNR associated with one or more MBS resources on a second SIM associated with a second data subscription; and
switch a default data subscription from the first data subscription to the second data subscription responsive to the second SNR satisfying a second condition.

2. The UE of claim 1, wherein the one or more processors are further individually or collectively configured to, when executing the processor-executable code, cause the UE to:
receive one or more subsequent MBS transmissions via the second SIM associated with the second data subscription responsive to switching the default data subscription from the first data subscription to the second data subscription.

3. The UE of claim 1, wherein the first SNR fails to satisfy the first condition responsive to the first SNR failing to satisfy a threshold value.

4. The UE of claim 3, wherein the first SNR fails to satisfy the first condition responsive to the first SNR failing to satisfy the threshold value for a threshold duration.

5. The UE of claim 1, wherein the second SNR satisfies the second condition responsive to the second SNR satisfying a threshold value.

6. The UE of claim 5, wherein the second SNR satisfies the second condition responsive to the second SNR satisfying the threshold value for a threshold duration.

7. The UE of claim 1, wherein the one or more processors are further individually or collectively configured to, when executing the processor-executable code, cause the UE to:
start a timer responsive to switching the default data subscription from the first data subscription to the second data subscription; and
maintain the second data subscription as the default data subscription at least until the timer expires.

8. The UE of claim 1, wherein, to cause the UE to switch the default data subscription, the one or more processors are individually or collectively configured to, when executing the processor-executable code, cause the UE to:
select, among one or more cells associated with the second data subscription that support MBS, an available cell satisfying one or more criteria.

9. The UE of claim 1, wherein the one or more processors are further individually or collectively configured to, when executing the processor-executable code, cause the UE to:
store or maintaining information that indicates one or more MBS frequencies for the first data subscription and one or more MBS frequencies for the second data subscription, wherein the second SNR is measured responsive to the information indicating that the one or more MBS frequencies for the second data subscription support a service or a stream associated with the one or more MBS transmissions received via the first SIM.

10. The UE of claim 9, wherein the information that indicates the one or more MBS frequencies for the first data subscription includes one or more service identifiers or temporary mobile group identities (TMGIs) associated with the one or more MBS frequencies for the first data subscription, and wherein the information that indicates the one or more MBS frequencies for the second data subscription includes one or more service identifiers or TMGIs associated with the one or more MBS frequencies for the second data subscription.

11. The UE of claim 9, wherein the information that indicates the one or more MBS frequencies for the first data subscription and the one or more MBS frequencies for the second data subscription is configured by an original equipment manufacturer.

12. The UE of claim 9, wherein the one or more processors are further individually or collectively configured to, when executing the processor-executable code, cause the UE to:
receive, from a network node, the information that indicates the one or more MBS frequencies for the first data subscription and the one or more MBS frequencies for the second data subscription.

13. A method for wireless communication by a user equipment (UE), comprising:
measuring a first signal-to-noise ratio (SNR) associated with one or more multicast-broadcast services (MBS) transmissions received via a first subscriber identity module (SIM) associated with a first data subscription;
measuring, responsive to the first SNR failing to satisfy a first condition, a second SNR associated with one or more MBS resources on a second SIM associated with a second data subscription; and
switching a default data subscription from the first data subscription to the second data subscription responsive to the second SNR satisfying a second condition.

14. The method of claim 13, further comprising:
receiving one or more subsequent MBS transmissions via the second SIM associated with the second data subscription responsive to switching the default data subscription from the first data subscription to the second data subscription.

15. The method of claim 13, wherein the first SNR fails to satisfy the first condition responsive to the first SNR failing to satisfy a threshold value.

16. The method of claim 15, wherein the first SNR fails to satisfy the first condition responsive to the first SNR failing to satisfy the threshold value for a threshold duration.

17. The method of claim 13, wherein the second SNR satisfies the second condition responsive to the second SNR satisfying a threshold value.

18. The method of claim 17, wherein the second SNR satisfies the second condition responsive to the second SNR satisfying the threshold value for a threshold duration.

19. The method of claim 13, further comprising:
starting a timer responsive to switching the default data subscription from the first data subscription to the second data subscription; and
maintaining the second data subscription as the default data subscription at least until the timer expires.

20. The method of claim 13, wherein switching the default data subscription includes:
selecting, among one or more cells associated with the second data subscription that support MBS, an available cell satisfying one or more criteria.

21. The method of claim 13, further comprising:
storing or maintaining information that indicates one or more MBS frequencies for the first data subscription and one or more MBS frequencies for the second data subscription, wherein the second SNR is measured responsive to the information indicating that the one or more MBS frequencies for the second data subscription support a service or a stream associated with the one or more MBS transmissions received via the first SIM.

22. The method of claim 21, wherein the information that indicates the one or more MBS frequencies for the first data subscription includes one or more service identifiers or temporary mobile group identities (TMGIs) associated with the one or more MBS frequencies for the first data subscription, and wherein the information that indicates the one or more MBS frequencies for the second data subscription includes one or more service identifiers or TMGIs associated with the one or more MBS frequencies for the second data subscription.

23. The method of claim 21, wherein the information that indicates the one or more MBS frequencies for the first data subscription and the one or more MBS frequencies for the second data subscription is configured by an original equipment manufacturer.

24. The method of claim 21, further comprising:
receiving, from a network node, the information that indicates the one or more MBS frequencies for the first data subscription and the one or more MBS frequencies for the second data subscription.

25. A non-transitory computer-readable medium storing a set of instructions for wireless communication, the set of instructions comprising:
one or more instructions that, when executed by one or more processors of a user equipment (UE), cause the UE to:
measure a first signal-to-noise ratio (SNR) associated with one or more multicast-broadcast services (MBS) transmissions received via a first subscriber identity module (SIM) associated with a first data subscription;
measure, responsive to the first SNR failing to satisfy a first condition, a second SNR associated with one or more MBS resources on a second SIM associated with a second data subscription; and
switch a default data subscription from the first data subscription to the second data subscription responsive to the second SNR satisfying a second condition.

26. The non-transitory computer-readable medium of claim 25, wherein the one or more instructions, when executed by the one or more processors of the UE, further cause the UE to:
receive one or more subsequent MBS transmissions via the second SIM associated with the second data subscription responsive to switching the default data subscription from the first data subscription to the second data subscription.

27. The non-transitory computer-readable medium of claim 25, wherein the first SNR fails to satisfy the first condition responsive to the first SNR failing to satisfy a threshold value.

28. The non-transitory computer-readable medium of claim 25, wherein the first SNR fails to satisfy the first condition responsive to the first SNR failing to satisfy the threshold value for a threshold duration.

29. The non-transitory computer-readable medium of claim 25, wherein the second SNR satisfies the second condition responsive to the second SNR satisfying a threshold value.

30. The non-transitory computer-readable medium of claim 29, wherein the second SNR satisfies the second condition responsive to the second SNR satisfying the threshold value for a threshold duration.

31. The non-transitory computer-readable medium of claim 25, wherein the one or more instructions, when executed by the one or more processors of the UE, further cause the UE to:
start a timer responsive to switching the default data subscription from the first data subscription to the second data subscription; and
maintain the second data subscription as the default data subscription at least until the timer expires.

32. The non-transitory computer-readable medium of claim 25, wherein the one or more instructions, to switch the default data subscription, further cause the UE:
select, among one or more cells associated with the second data subscription that support MBS, an available cell satisfying one or more criteria.

33. The non-transitory computer-readable medium of claim 25, wherein the one or more instructions, when executed by the one or more processors of the UE, further cause the UE to:
store or maintain information that indicates one or more MBS frequencies for the first data subscription and one or more MBS frequencies for the second data subscription, wherein the second SNR is measured responsive to the information indicating that the one or more MBS frequencies for the second data subscription support a service or a stream associated with the one or more MBS transmissions received via the first SIM.

34. The non-transitory computer-readable medium of claim 33, wherein the information that indicates the one or more MBS frequencies for the first data subscription includes one or more service identifiers or temporary mobile group identities (TMGIs) associated with the one or more MBS frequencies for the first data subscription, and wherein the information that indicates the one or more MBS frequencies for the second data subscription includes one or more service identifiers or TMGIs associated with the one or more MBS frequencies for the second data subscription.

35. The non-transitory computer-readable medium of claim 33, wherein the information that indicates the one or more MBS frequencies for the first data subscription and the one or more MBS frequencies for the second data subscription is configured by an original equipment manufacturer.

36. The non-transitory computer-readable medium of claim 33, wherein the one or more instructions, when executed by the one or more processors of the UE, further cause the UE to:
receive, from a network node, the information that indicates the one or more MBS frequencies for the first data subscription and the one or more MBS frequencies for the second data subscription.

37. An apparatus for wireless communication, comprising:
means for measuring a first signal-to-noise ratio (SNR) associated with one or more multicast-broadcast services (MBS) transmissions received via a first subscriber identity module (SIM) associated with a first data subscription;
means for measuring, responsive to the first SNR failing to satisfy a first condition, a second SNR associated with one or more MBS resources on a second SIM associated with a second data subscription; and
means for switching a default data subscription from the first data subscription to the second data subscription responsive to the second SNR satisfying a second condition.

38. The apparatus of claim 37, further comprising:
means for receiving one or more subsequent MBS transmissions via the second SIM associated with the second data subscription responsive to switching the default data subscription from the first data subscription to the second data subscription.

39. The apparatus of claim 37, wherein the first SNR fails to satisfy the first condition responsive to the first SNR failing to satisfy a threshold value.

40. The apparatus of claim 37, wherein the first SNR fails to satisfy the first condition responsive to the first SNR failing to satisfy the threshold value for a threshold duration.

41. The apparatus of claim 37, wherein the second SNR satisfies the second condition responsive to the second SNR satisfying a threshold value.

42. The apparatus of claim 41, wherein the second SNR satisfies the second condition responsive to the second SNR satisfying the threshold value for a threshold duration.

43. The apparatus of claim 37, further comprising:
means for starting a timer responsive to switching the default data subscription from the first data subscription to the second data subscription; and
means for maintaining the second data subscription as the default data subscription at least until the timer expires.

44. The apparatus of claim 37, wherein the means for switching the default data subscription includes:
means for selecting, among one or more cells associated with the second data subscription that support MBS, an available cell satisfying one or more criteria.

45. The apparatus of claim 37, further comprising:
means for storing or maintaining information that indicates one or more MBS frequencies for the first data subscription and one or more MBS frequencies for the second data subscription, wherein the second SNR is measured responsive to the information indicating that the one or more MBS frequencies for the second data subscription support a service or a stream associated with the one or more MBS transmissions received via the first SIM.

46. The apparatus of claim 45, wherein the information that indicates the one or more MBS frequencies for the first data subscription includes one or more service identifiers or temporary mobile group identities (TMGIs) associated with the one or more MBS frequencies for the first data subscription, and wherein the information that indicates the one or more MBS frequencies for the second data subscription includes one or more service identifiers or TMGIs associated with the one or more MBS frequencies for the second data subscription.

47. The apparatus of claim 45, wherein the information that indicates the one or more MBS frequencies for the first data subscription and the one or more MBS frequencies for the second data subscription is configured by an original equipment manufacturer.

48. The apparatus of claim 45, further comprising:
means for receiving, from a network node, the information that indicates the one or more MBS frequencies for the first data subscription and the one or more MBS frequencies for the second data subscription.
